(19) United States
(12) Patent Application Publication
(10) Pub. No.: US 2008/0211194 A1
(43) Pub. Date: Sep. 4, 2008

(54) METHOD FOR PRODUCING A HOLLOW PART MADE OF AT LEAST TWO PORTIONS, AND PART OBTAINED

(76) Inventors: Denis Menin, Labaroche (FR); Laurent Germain, Jeuxey (FR); Lionel Verchere, Ingersheim (FR)

Correspondence Address: GOTTLIEB RACKMAN & REISMAN PC, 270 MADISON AVENUE, 8TH FLOOR, NEW YORK, NY, 10016-0601, US

(21) Appl. No.: 12/022,228

(22) Filed: Jan. 30, 2008

(30) Foreign Application Priority Data
Jan. 31, 2007 (FR) 0700677

(51) Int. Cl. F02F 11/00; B29C 57/10

(52) U.S. Cl. 277/594; 264/296

(57) ABSTRACT

A method for producing a hollow part formed from at least two portions joined together along respective adjacent edges, or at least portions of such edges, producing at the same time a seal in the region of the assembly zone, the method consisting in producing a first portion by moulding of a first thermoplastic material, this first portion comprising at least one rib or ridge protruding in the region of its edge or its assembly edge portion, then in producing a second portion by moulding onto the first portion of a second thermoplastic material, with at least partial overmoulding of the edge or the assembly edge portion of the first portion by the second material mass forming the edge or the assembly edge portion of the second portion, or an extension of this edge, said second material entirely covering said at least one rib or ridge.

The present invention relates to the field of hollow parts made of thermoplastic material and to methods for the production thereof, more specifically to hollow parts of the aforementioned type formed from at least two portions joined together in a tight manner.

The present invention relates to a method for producing a part of this type and also to a part obtained using this method.

### BACKGROUND OF THE INVENTION

Currently, hollow parts of this type, intended for example to contain a liquid or gaseous fluid, are generally produced by separate manufacture of the two constituent portions, then joining together of said portions in the region of assembly interfaces, usually respective peripheral edges of said portions having cooperating complementary shapes.

These two portions are generally assembled in the region of their opposing edges, a seal being produced at the same time, by one of the following four assembly method variations:
vibration welding,
adhesion,
screwing or similar mechanical connection with compression of a seal,
production of an overmould, in the region of the adjacent edges, the attached overmoulded material forming the mechanical connection and the seal between the two opposing edges.

### SUMMARY OF THE INVENTION

The problem posed to the present invention is that of providing a new embodiment of hollow parts of the aforementioned type, with improved assembly and sealing performance levels, which requires fewer production operations, which uses no additional element or material other than the two portions to be assembled and which is more economical.

The invention solves this problem using a method for producing a hollow part formed from at least two portions joined together along respective adjacent edges, or at least portions of such edges, producing at the same time a seal in the region of the assembly zone, method characterised in that it consists in producing a first portion by moulding of a first thermoplastic material, this first portion comprising at least one rib or ridge protruding in the region of its edge or its assembly edge portion, then in producing a second portion by moulding onto the first portion of a second thermoplastic material, with at least partial overmoulding of the edge or the assembly edge portion of the first portion by the second material mass forming the edge or the assembly edge portion of the second portion, or an extension of this edge, said second material entirely covering said at least one rib or ridge.

### BRIEF DESCRIPTION OF THE DRAWINGS

A better understanding of the invention will be facilitated by the following description which relates to preferred embodiments given by way of non-limiting examples and explained with reference to the appended schematic drawings, in which:

FIGS. 1 to 5 are localised cross-sections of various variations of the assembly edges of two portions of a hollow part obtained by way of the production method according to the invention, and

FIGS. 6A, 6B and 6C are respectively a perspective view, a view from above and a cross-section (along the line B-B in FIG. 6B) of an intake manifold produced using the method according to the invention and comprising an assembly zone configured in accordance with the variation of FIG. 1 (detail D in FIG. 6C).

### DETAILED DESCRIPTION OF THE INVENTION

The production method according to the invention consists mainly in producing a first portion 2 by moulding of a first thermoplastic material, this first portion 2 comprising at least one rib or ridge 5 protruding in the region of its edge 3 or its assembly edge portion, then in producing a second portion 2′ by moulding onto the first portion 2 of a second thermoplastic material, with at least partial overmoulding of the edge or the assembly edge portion 3 of the first portion 2 by the second material mass forming the edge 3′ or the assembly edge portion of the second portion 2′, or an extension 6 of this edge 3, said second material entirely covering said at least one rib or ridge 5.

In order to obtain, in addition to the mechanical locking resulting from the overmoulding, connection by chemical adherence in the region of the interfaces between the materials forming the two portions 2 and 2′, the amount of heat conveyed by the second material mass forming the edge 3′ or the assembly edge portion of the second portion 2′, or an extension 6 of this edge 3, and entering into contact with said at least one rib or ridge 5, is sufficient to obtain at least partial melting of the material forming this or each rib or ridge 5, preferably in the region of its free end 5′.

By regulating the time interval separating the end of the moulding of the first portion 2 from the start of the moulding of the second portion 2′ and also the temperature and the amount of the overmoulded material attached in the region of the assembly zone 4, it is possible to achieve in a targeted manner either mere softening of the ribs or ridges 5, their shape being maintained and with melting solely at the surface thereof, or more pronounced and quantitively greater melting of the constituent material thereof, with sensitive modification of their original shape and, if appropriate, interpenetration and mixing of the two constituent materials in the region of the mutual interface thereof (thus also strengthening the mechanical and physical connection between the two portions 2 and 2′).

The aforementioned provisions can be reinforced by providing that the first and second thermoplastic materials are mutually compatible and of the same type, that the or each rib or ridge 5 having a profiled structure is formed integrally with the edge or the assembly edge portion 3 of the first portion 2 by having a configuration such that its outer surface area visible before overmoulding is large compared to its volume.

Moreover, the base 5″ of the ridge or rib 5, which adjoins the edge or the edge portion 3, has a widened shape or cross-section relative to the remainder of the rib or ridge 5 in question, in order to ensure that the rib or ridge 5 in question remains integral with the first portion 2.

The contribution of heat during the overmoulding also affects the remaining surface area of the edge 3 brought into contact with the second injected hot material and can be sufficient thus partially to melt a layer of surface material in this region, increasing in this way the adherence between the two portions 2 and 2′.

Advantageously and in order to promote the phenomenon of melting of the first material for the regions of the rib or ridge 5 penetrating most deeply into the mass of the second overmoulded material, the or each rib or ridge 5 has, in section along a plane perpendicular to its profiled extension direction, a shape tapered from its base 5″ adjoining the edge or the edge portion 3 toward its free end 5′.

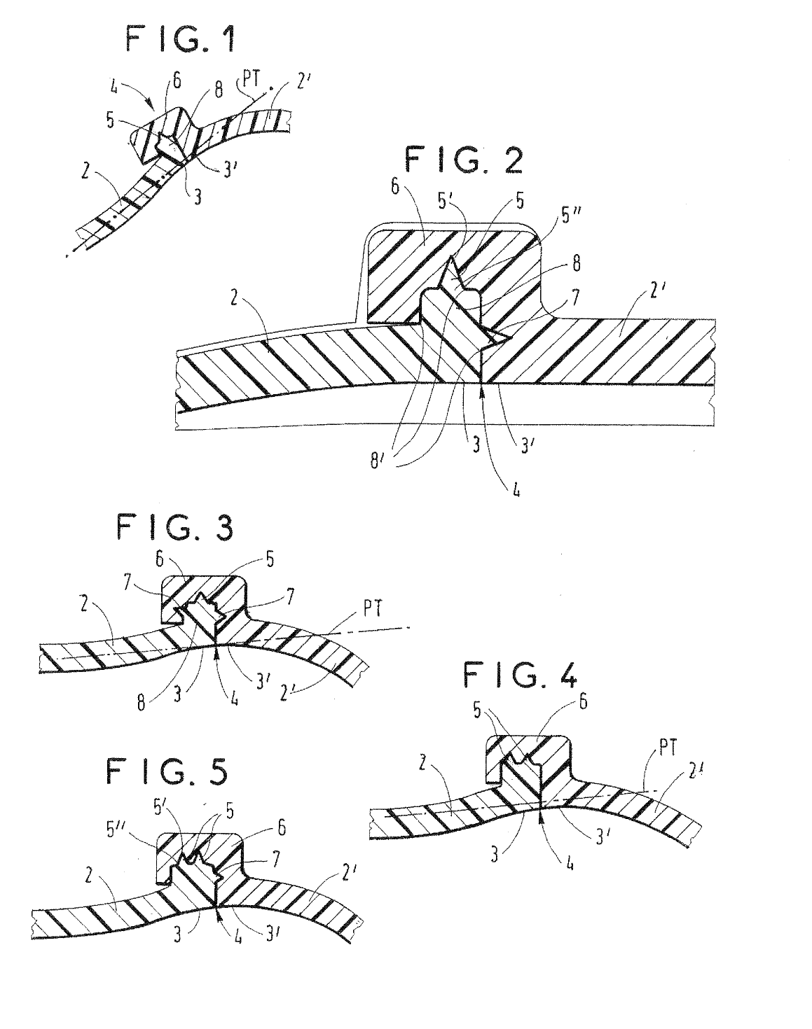

According to a preferred embodiment and as shown in FIGS. 1 to 6 of the appended drawings, the or each rib or ridge 5 has a substantially prismatic shape, with a cross-section in the shape of a triangle, preferably an isosceles triangle.

In the case of a hollow part 1 intended for the circulation of gaseous or liquid fluid, the internal facade of the wall of this part 1 will preferably be continuous, i.e. without indentation, projection or a difference in level in the region of the assembly zone 4 (FIGS. 1 to 6).

In accordance with a first variation of the invention emerging from FIGS. 1 to 3 and 6, the edge or the assembly edge portion 3 of the first portion 2 comprises a ridge or rib 5 protruding outward, preferably in a direction substantially perpendicular to the tangential or median plane PT of the wall of the hollow part 1 in the region of the assembly zone 4.

In order to reinforce the degree of strength and tightness between the two portions 2 and 2′ in the region of the assembly zone 4 and in accordance with a second variation of the invention illustrated in FIGS. 4 and 5, it can be provided that the edge or the assembly edge portion 3 of the first portion 2 comprises at least two ridges or ribs 5 substantially mutually parallel in their longitudinal extension and protruding outward, preferably in a direction substantially perpendicular to the tangential or median plane PT of the wall of the hollow part 1 in the region of the assembly zone 4.

Each rib or ridge 5 according to the two variations referred to hereinbefore is thus subjected to a shear force in the event of application of a stress tending to separate the two portions 2 and 2′, in particular under the action of internal pressure in the hollow part 1 (hence the benefit of a widened base 5″).

According to an additional feature emerging from FIGS. 2, 3 and 5, at least one additional rib or ridge 7 is also formed in the region of the edge 3 or the assembly edge portion 3 of the second portion 2, this or each additional rib or ridge 7 protruding in a direction substantially parallel to or comprised within the tangential or median plane PT of the wall of the hollow part 1 in the region of the assembly zone 4.

Each additional rib or ridge 7 can be directed toward or away from the second portion 2′ and will mechanically secure the edge 3′ of the second portion 2′ relative to the first portion 2 in the direction of extension of the other rib(s) or ridge(s) 5.

Each rib or ridge 5 and/or 7 preferably extends continuously over the entire periphery of the edge 3 of the first portion 2 but can also extend discontinuously merely over one or more portion(s) of this periphery, the connection in the region of the remaining portions of the assembly zone 4 between the two constituent portions 2 and 2′ of the part being produced by other means in the absence of the assembly according to the invention.

It can thus be provided that at least one region of the first portion 2 is formed with a recess, a passage, a cavity or the like 9, and the second thermoplastic material penetrates this recess or the like 9 during the moulding of the second portion 2′, to produce a tight mechanical connection to the first portion 2.

According to a particularly preferred embodiment of the invention emerging from the appended drawings, the edge or the assembly edge portion 3 of the first portion 2 is formed with a thickening 8 forming an outwardly directed rim, the rib(s) or ridge(s) 5 being formed integrally on and with this rim 8, optionally on a plurality of faces 8′ thereof, the edge or the assembly edge portion 3′ of the second portion 2′ being formed integrally with a lateral extension 6 in the form of a covering wing, engaging by overmoulding at least partially, preferably completely, above said thickening 8 in order to form a lock-on connection.

Thus, the edges 3 and 3′ produce a shape-mating lock-on connection simply by virtue of their general shape.

Moreover, the provision of a thickening 8 in the region of the edge 3 increases the mechanical strength of said edge and provides a larger abutment surface area in the region of the assembly zone 4.

Obviously, the two portions 2 and 2′, in the form of shell-shaped portions, can be produced in two different moulds, the first portion 2 being transferred from a first mould to a second mould and the second portion 2′ being overmoulded (an interval for solidification/cooling of the first portion 2 being allowed for).

However, according to an economically highly advantageous variation, the operation of moulding the first portion 2 of the part 1 and the subsequent operation of overmoulding the second portion 2′ are carried out in the same mould, said mould being provided with two separate moulding sites, of suitable matching shapes, or with a moulding cavity having a configuration which can be modified or varied in a controlled manner.

Although the invention has been described above in relation to the production of a hollow part consisting of two portions 2 and 2′, it can obviously also apply to the production of a part 1 consisting of three or more portions, by repeating the overmoulding operation, a third portion being formed over the assembly formed by the first and second portions 2 and 2′.

In the application, the method can then consist in forming the second portion 2′ with a second edge or assembly edge portion provided with at least one protruding rib or ridge 5 and, after moulding of the second portion 2′ with connection to the first portion 2 by overmoulding, in moulding a third portion onto said second portion 2′, with at least partial overmoulding of said second edge or said second assembly edge portion of the second portion by the material mass forming an edge or an assembly edge portion of said second portion, this material mass entirely covering said at least one rib or ridge of said second edge or said second assembly edge portion of said second portion 2′ (not shown).

The invention also relates to a hollow part made of thermoplastic material(s) preferably obtained using the production method described hereinbefore and consisting of two portions joined together along respective adjacent edges or at least portions of such edges, producing at the same time a seal in the region of the assembly zone.

This part 1 is characterised in that the first portion 2 consists of a moulded portion made of a first thermoplastic material and comprising at least one rib or ridge 5 protruding in the region of its edge or its assembly edge portion 3 and in that the second portion 2′ consists of a moulded portion made of a second thermoplastic material, the second material mass forming the edge or the assembly edge portion 3′ of the second portion 2′, or an extension 6 of this edge 3′ overmoulding at least partially the edge or the assembly edge portion 3 of the first portion 2, said second material entirely covering said at least one rib or ridge 5.

The first and second materials can, for example, consist of PA6GF30 or PA66GF35, the melting point of the second material advantageously being equal to or slightly higher than the melting point of the first material.

During the injection of the material forming the second portion, via a limited number of injection orifices, this material will have a temperature and fluidity sufficient to cover the entire assembly interface of the first portion and at least partially to melt said at least one ridge.

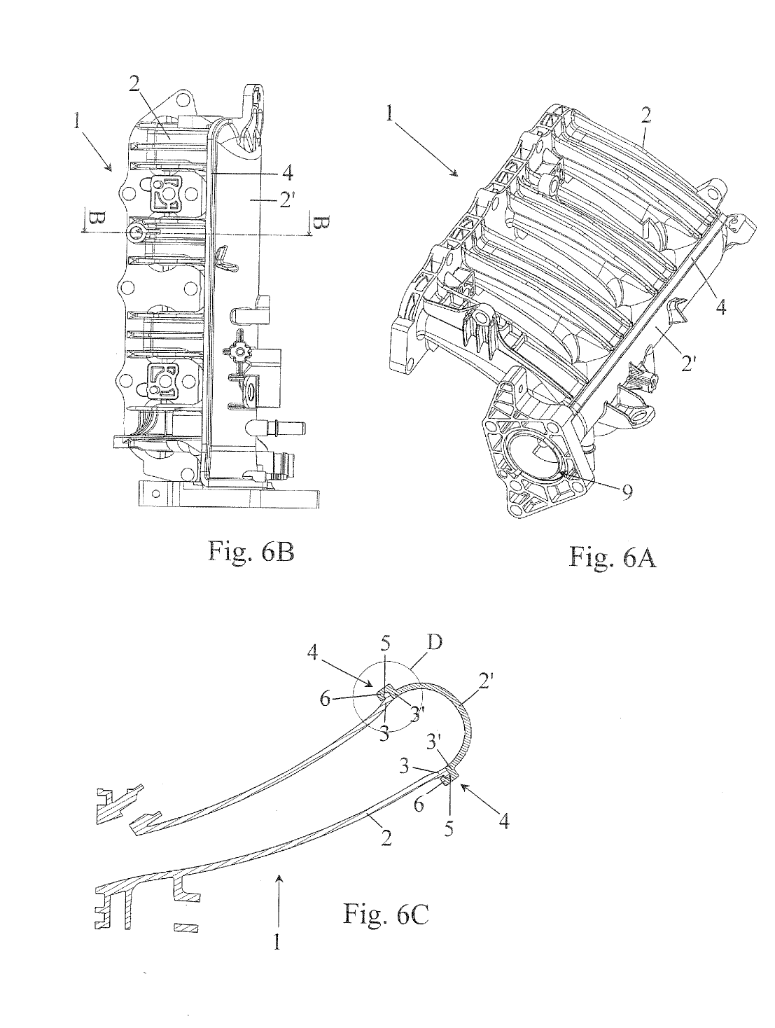

As shown in FIGS. 6A, 6B and 6C, said part advantageously consists of an intake manifold or distributor for a vehicle having an internal-combustion engine.

Obviously, the invention is not limited to the embodiments described and illustrated in the appended drawings. Modifications are possible, in particular with regard to the constitution of the various elements or by substitution of technical equivalents, without thereby departing from the scope of protection of the invention.

1. Method for producing a hollow part formed from at least two portions joined together along respective adjacent edges, or at least portions of such edges, producing at the same time a seal in the region of the assembly zone, method characterised in that it consists in producing a first portion (2) by moulding of a first thermoplastic material, this first portion (2) comprising at least one rib or ridge (5) protruding in the region of its edge (3) or its assembly edge portion, then in producing a second portion (2′) by moulding onto the first portion (2) of a second thermoplastic material, with at least partial overmoulding of the edge or the assembly edge portion (3) of the first portion (2) by the second material mass forming the edge (3′) or the assembly edge portion of the second portion (2′), or an extension (6) of this edge (3), said second material entirely covering said at least one rib or ridge (5).

2. Production method according to claim 1, characterised in that the amount of heat conveyed by the second material mass forming the edge (3′) or the assembly edge portion of the second portion (2′), or an extension (6) of this edge (3), and entering into contact with said at least one rib or ridge (5), is sufficient to obtain at least partial melting of the material forming this or each rib or ridge (5), preferably in the region of its free end (5′).

3. Production method according to claim 1, characterised in that the first and second thermoplastic materials are mutually compatible and of the same type, in that the or each rib or ridge (5) having a profiled structure is formed integrally with the edge or the assembly edge portion (3) of the first portion (2) by having a configuration such that its outer surface area visible before overmoulding is large compared to its volume and that its base (5″) adjoining the edge or the edge portion (3) has a widened shape or cross-section relative to the remainder of the rib or ridge (5) in question.

4. Production method according to claim 1, characterised in that the or each rib or ridge (5) has, in section along a plane perpendicular to its profiled extension direction, a shape tapered from its base (5″) adjoining the edge or the edge portion (3) toward its free end (5′).

5. Production method according to claim 1, characterised in that the or each rib or ridge (5) has a substantially prismatic shape, with a cross-section in the shape of a triangle, preferably an isosceles triangle.

6. Production method according to claim 1, characterised in that the edge or the assembly edge portion (3) of the first portion (2) comprises a ridge or rib (5) protruding outward, preferably in a direction substantially perpendicular to the tangential or median plane (PT) of the wall of the hollow part (1) in the region of the assembly zone (4).

7. Production method according to claim 1, characterised in that the edge or the assembly edge portion (3) of the first portion (2) comprises at least two ridges or ribs (5) substantially mutually parallel in their longitudinal extension and protruding outward, preferably in a direction substantially perpendicular to the tangential or median plane (PT) of the wall of the hollow part (1) in the region of the assembly zone (4).

8. Production method according to claim 6, characterised in that at least one additional rib or ridge (7) is also formed in the region of the edge (3) or the assembly edge portion (3) of the first portion (2), this or each additional rib or ridge (7) protruding in a direction substantially parallel to or comprised within the tangential or median plane (PT) of the wall of the hollow part (1) in the region of the assembly zone (4).

9. Production method according to claim 1, characterised in that the edge or the assembly edge portion (3) of the first portion (2) is formed with a thickening (8) forming an outwardly directed rim, the rib(s) or ridge(s) (5) being formed integrally on and with this rim (8), optionally on a plurality of faces (8′) thereof, the edge or the assembly edge portion (3′) of the second portion (2′) being formed integrally with a lateral extension (6) in the form of a covering wing, engaging by overmoulding at least partially, preferably completely, above said thickening (8) in order to form a lock-on connection.

10. Production method according to claim 1, characterised in that at least one region of the first portion (2) is formed with a recess, a passage, a cavity or the like (9), and in that the second thermoplastic material penetrates this recess or the like (9) during the moulding of the second portion (2′).

11. Production method according to claim 1, characterised in that the operation of moulding the first portion (2) of the part (1) and the subsequent operation of overmoulding the second portion (2′) are carried out in the same mould, said mould being provided with two separate moulding sites, of suitable matching shapes, or with a moulding cavity having a configuration which can be modified or varied in a controlled manner.

12. Method according to claim 1, characterised in that it consists in forming the second portion (2′) with a second edge or assembly edge portion provided with at least one protruding rib or ridge (5) and, after moulding of the second portion (2′) with connection to the first portion (2) by overmoulding, in moulding a third portion onto said second portion (2′), with at least partial overmoulding of said second edge or said second assembly edge portion of the second portion by the material mass forming an edge or an assembly edge portion of said second portion, this material mass entirely covering said at least one rib or ridge of said second edge or said second assembly edge portion of said second portion (2′).

13. Hollow part made of thermoplastic material(s) preferably obtained using the production method according to claim 1 and consisting of two portions joined together along respective adjacent edges or at least portions of such edges, producing at the same time a seal in the region of the assembly zone, characterised in that the first portion (2) consists of a moulded portion made of a first thermoplastic material and comprising at least one rib or ridge (5) protruding in the region of its edge or its assembly edge portion (3) and in that the second portion (2′) consists of a moulded portion made of a second thermoplastic material, the second material mass forming the edge or the assembly edge portion (3′) of the second portion (2′), or an extension (6) of this edge (3′) overmoulding at least partially the edge or the assembly edge portion (3) of the first portion (2), said second material entirely covering said at least one rib or ridge (5).

14. Hollow part according to claim 13, characterised in that it consists of an intake manifold or distributor for a vehicle having an internal-combustion engine.
